(19) United States
(12) Patent Application Publication
(10) Pub. No.: US 2011/0014466 A1
(43) Pub. Date: Jan. 20, 2011

(54) COMPOSITE MATERIALS COMPRISING CORE-SHELL NANO-FIBRILS

(75) Inventors: Nan-Xing HU, Oakville (CA); Yu Qi, Oakville (CA)

Correspondence Address: MH2 TECHNOLOGY LAW GROUP, LLP (CUST. NO. W/XEROX), 1951 KIDWELL DRIVE, SUITE 550, TYSONS CORNER, VA, 22182, US

(73) Assignee: XEROX CORPORATION, Norwalk, CT (US)

(21) Appl. No.: 12/504,995

(22) Filed: Jul. 17, 2009

(51) Int. Cl. B32B 19/02

(52) U.S. Cl. 428/367; 427/189; 427/190; 427/195; 977/753

(57) ABSTRACT

Exemplary embodiments provide materials and methods for composite materials that can include core-shell nano-fibril fillers dispersed in a plastic matrix, the core-shell nano-fibril filler including a carbon nanotube surrounded by a soft shell that includes one or more elastomers.

### DETAILED DESCRIPTION

1. Field of Use

The present teachings relate generally to composite materials and, more particularly, to a composite material having core-shell nano-fibrils dispersed in a plastic matrix.

2. Background

Plastic polymers, such as crystalline, semi-crystalline, or glass polymers, have been widely used in numerous applications. However, these materials are generally prone to ductile failure due to their inherent brittleness. One of the most commonly-used strategies to solve the brittle problems of plastic polymers includes addition of rubber fillers. Rubber fillers often include cavitations Hydrostatic pressure generated in the polymer matrix may be relieved near the voids of the cavitations and the stress that causes fracture failure may be redistributed in the polymer matrix. Fracture toughness may then be significantly improved, although the rubber-toughened plastic polymers typically result in dramatic drop in mechanical modulus.

Conventional methods to address modulus drop issues include use of block copolymers that have a “hard” block and a “soft” block. Specific block copolymers with a control of morphology and a control of domain sizes for different polymers are then needed to be synthesized.

Thus, there is a need to overcome these and other problems of the prior art and to provide a “non-brittle” or toughened plastic material as a composite material including core-shell nano-fibril fillers but with improved mechanical modulus.

### SUMMARY

According to various embodiments, the present teachings include a composite material. The composite material can include a matrix having one or more plastic polymers with a plurality of core-shell nano-fibril fillers dispersed therein. The core-shell nano-fibril filler can further include a carbon nanotube surrounded by a shell layer of one or more elastomers.

According to various embodiments, the present teachings also include a method for making a composite material. Carbon nanotubes, one or more elastomers, and a plastic polymer can be mixed together in this method to form a coating composition. The elastomer can be capable of being attached to the carbon nanotube as a shell layer surrounding the carbon nanotube core. The coating composition can then be applied to a substrate and be solidified to form a composite material that includes a plurality of core-shell nano-fibrils dispersed in a plastic matrix formed by the plastic polymer. Each core-shell nano-fibril can be formed to include an elastomer shell surrounding the carbon nanotube.

Additional objects and advantages of the present teachings will be set forth in part in the description which follows, and in part will be obvious from the description, or may be learned by practice of the present teachings. The objects and advantages of the present teachings will be realized and attained by means of the elements and combinations particularly pointed out in the appended claims.

It is to be understood that both the foregoing general description and the following detailed description are exemplary and explanatory only and are not restrictive of the present teachings, as claimed.

### BRIEF DESCRIPTION OF THE DRAWINGS

The accompanying drawings, which are incorporated in and constitute a part of this specification, illustrate several embodiments of the present teachings and together with the description, serve to explain the principles of the present teachings.

FIG. 1 schematically illustrates an exemplary composite material in accordance with various embodiments of present teachings.

FIG. 1A schematically illustrates an exemplary core-shell nano-fibril filler in accordance with various embodiments of present teachings.

FIGS. 2-3 illustrate an exemplary method for making a composite material in accordance with various embodiments of the present teachings.

It should be noted that some details of the FIGS. have been simplified and are drawn to facilitate understanding of the embodiments rather than to maintain strict structural accuracy, detail, and scale.

### DESCRIPTION OF THE EMBODIMENTS

Reference will now be made in detail to embodiments of the present teachings, examples of which are illustrated in the accompanying drawings. Wherever possible, the same reference numbers will be used throughout the drawings to refer to the same or like parts.

In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings and it is to be understood that other embodiments may be utilized and that changes may be made without departing from the scope of the present teachings The following description is, therefore, merely exemplary.

Exemplary embodiments provide materials and methods for composite materials that include core-shell nano-fibrils dispersed in a plastic matrix.

As disclosed herein, the term “core-shell nano-fibril” refers to a filler material that includes a core element having a shell layer there-over. In various embodiments, the core element can be a hard core including, for example, carbon nanotube, while the shell layer can be a soft shell including, for example, one or more elastomers

The core-shell nano-fibrils can be dispersed within the plastic matrix to form a composite material. In various embodiments, the plastic matrix can be crystalline, semi-crystalline, or a glass, and may be “brittle”. The incorporation of the disclosed core-shell nano-fibrils, which include, for example, a soft shell on a hard/stiff core of carbon nanotubes with a high aspect ratio, can be used to effectively toughen the brittle plastic matrix to provide a non-brittle composite material with improved mechanical properties.

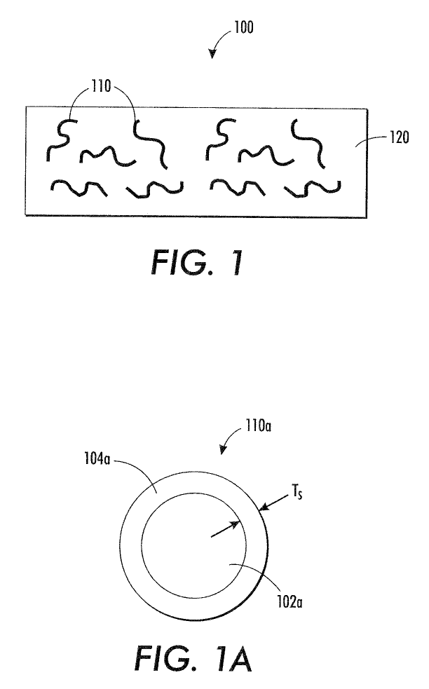

FIG. 1 schematically illustrates an exemplary composite material 100 in accordance with various embodiments of present teachings. It should be readily apparent to one of ordinary skill in the art that the material 100 depicted in FIG. 1 represents a generalized schematic illustration and that other components/fillers/particles can be added or existing components/fillers/particles can be removed or modified.

As shown, the composite material 100 can include a plurality of core-shell nano-fibrils 110 dispersed in a plastic polymer matrix 120. In various embodiments, the core-shell nano-fibrils 110 can be dispersed randomly, uniformly, and/or spatially-controlled in the plastic polymer matrix 120. The polymer matrix 120 can include one or more plastic materials as disclosed herein.

As disclosed herein, the plastic matrix 120 can include one or more plastic materials including, for example, a thermoplastic polymer and/or a thermosetting polymer.

In one embodiment, the thermoplastic polymer can include, for example, a polymer having one or more monomeric repeat units selected from the group consisting of ethylene, propylene, styrene, vinyl chloride, tetrafluoroethylene, vinylidene fluoride, hexafluoropropylene, chlorotrifluoroethylene, perfluoro(methyl vinyl ether), perfluoro(ethyl vinyl ether), perfluoro(propyl vinyl ether), and the mixtures thereof.

In another embodiment, the thermoplastic polymer can include, for example, polyethylene, polypropylene, polystyrene, poly(vinyl chloride), fluoroplastics, polyacetal, acrylic, polyamide, polycarbonate, polyester, polyphenylene oxide, polyketone, polysulfone, polyetheretherketone, polyether-imide, polyimide, or mixtures thereof.

In various embodiments, the thermosetting polymer can include, for example, epoxy, melamine-formaldehyde, urea-formaldehyde, unsaturated polyester, phenolic resin, alkyl, polyurethane, or mixtures thereof.

In various embodiments, the plastic polymer matrix 120 can also include one or more plastic materials including, but not limited to, a crystalline polymer, a semi-crystalline polymer, an amorphous polymer or mixtures thereof.

FIG. 1A schematically illustrates an exemplary core-shell nano-fibril 110a in accordance with various embodiments of present teachings. As shown, the core-shell nano-fibril 110a can include a carbon nanotube 102a surrounded by a soft shell 104a.

As used herein and unless otherwise specified, the term “carbon nanotube” or CNT refers to an elongated carbon material that has at least one minor dimension, for example, width or diameter, of at least about 100 nanometers. In various embodiments, the CNT can have an average diameter ranging from about 1 nm to about 100 nm, or in some cases, from about 10 nm to about 50 nm.

In various embodiments, the carbon nanotubes can include, but are not limited to, carbon nanoshafts, carbon nanopillars, carbon nanowires, carbon nanorods, and carbon nanoneedles and their various functionalized and derivatized fibril forms, which include carbon nanofibers with exemplary forms of thread, yarn, fabrics, etc. In one embodiment, the CNTs can be considered as one atom thick layers of graphite, called graphene sheets, rolled up into nanometer-sized cylinders, tubes or other shapes.

In various embodiments, the carbon nanotubes or CNTs can include modified carbon nanotubes from all possible carbon nanotubes described above and their combinations: The modification of the carbon nanotubes can include a physical and/or a chemical modification.

In various embodiments, the carbon nanotubes or CNTs can include single wall carbon nanotubes (SWCNTs), multi-wall carbon nanotubes (MWCNTs), and their various functionalized and derivatized fibril forms such as carbon nanofibers, as exemplarily shown in FIG. 1.

The CNTs can be formed of conductive or semi-conductive materials In some embodiments, the CNTs can be obtained in low and/or high purity dried paper forms or can be purchased in various solutions. In other embodiments, the CNTs can be available in the as-processed unpurified condition, where a purification process can be subsequently carried out.

Although FIG. 1A schematically illustrates a circular cross section for the exemplary CNT 102a, however, one of ordinary skill in the art would understand that CNT core element of the core-shell nano-fibril 110 can have various other cross sectional shapes, regular or irregular, such as, for example, a rectangular, a polygonal, or an oval shape. Accordingly, the CNT 102a or the resulting core-shell nano-fibril 110 can have, for example, cylindrical 3-dimensional shapes.

As shown in FIG. 1A, the shell layer 104a can be a soft shell including elastomers or the like surrounding the carbon nanotube, the hard core.

As used herein, the term “elastomers” refers to substances emulating natural rubber in that they stretch under tension, have a high tensile strength, retract rapidly, and substantially recover their original dimensions (or even smaller in some embodiments). The term can include natural and/or man-made elastomers, and the elastomer can be a thermoplastic elastomer or a non-thermoplastic elastomer. The term can also include blends (physical mixtures) of elastomers, as well as copolymers, terpolymers, and multi-polymers.

Exemplary elastomers used for the shell layer 104a or the core-shell nano-fibril 110 can include various materials, for example, a polyolefin, a polybutadiene, a fluorocarbon elastomer, a silicone elastomer, a perfluoropolyether, or combinations thereof, such as their copolymers.

In embodiments, the elastomers used for the shell layer 104a or the core-shell nano-fibril 110 can include natural rubbers, synthetic rubbers or their combinations. For example, the elastomers can include a synthetic rubber selected from the group consisting of polyolefin that includes one or more monomeric repeat units of olefin having from 1 to about 12 carbons, fluoroelastomer, perfluoroelastomer, silicone, fluorosilicone, polysulfide, polyphosphazene, and mixtures thereof. In various embodiments, the elastomers used for the shell layer 104a or the core-shell nano-fibril 110 can be at least partially vulcanized.

Commercially available fluoroelastomers used for the shell layer 104a or the core-shell nano-fibril 110 can include, such as, for example, VITON® A (copolymers of hexafluoropropylene (HFP) and vinylidene fluoride (VDF or VF2)), VITON® B, (terpolymers of tetrafluoroethylene (TFE), vinylidene fluoride (VDF) and hexafluoropropylene (HFP)), and VITON® GF, (tetrapolymers of TFE, VF2, HFP), as well as VITON® E, VITON® E 60C, VITON® E430, VITON® 910, VITON® GH and VITON® GF. The VITON® designations are Trademarks of E.I. DuPont de Nemours, Inc. (Wilmington, Del.).

In a specific embodiment, the elastomers for the shell layer 104a or the core-shell nano-fibril 110 can include VITON-GF® (E.I. du Pont de Nemours, Inc.), including TEE, HFP, and VF2, and a cure site. Exemplary curing agent for this elastomer can include VITON® Curative No. 50 (VC-50) available from E.I. du Pont de Nemours, Inc. Curative VC-50 can contain Bisphenol-AF as a cross-linker and diphenylbenzylphosphonium chloride as an accelerator.

In embodiments, the shell layer 104a can have a shell thickness Tₛ on the outer surface of the CNT hard core 102a. In various embodiments, the shell thickness Tₛ can be at least about 1 nm in order to, for example, toughen the plastic polymer matrix when the formed core-shell nano-fibrils are dispersed in the polymer matrix. In embodiments, the shell thickness Tₛ can be in a range from about 1 nm to about 5 μm, or in some cases, from about 1 nm to about 1000 nm.

In various embodiments, the shell layer 104a can be attached to the CNT hard core 102a by physical or chemical bonds through, for example, a functional group of the elastomers that is capable of bonding with the carbon nanotubes. In an exemplary embodiment, the elastomeric materials used for the shell layer 104a can have a chemically functional group capable of reacting with CNT or modified CNT by a covalent bond so as to form a shell layer 104a surrounding the CNT 102a. The functional group can include, but is not limited to, hydroxyl, carboxylic acid, aziridine, azomethine ylide, aryl diazonium cation, oxazolidinone, and mixtures thereof.

In various embodiments, the elastomers used for the shell layer 104a of the core-shell nano-fibrils 110/110a can be present in an amount of from about 0.5% to 10% by weight of the plastic polymer matrix 120. In an additional example, the elastomers used for the shell layer 104a of the core-shell nano-fibrils 110/110a can be present in an amount of from about 1% to about 9% by weight of the plastic polymer matrix 120, or in some cases from about 2% to about 6% by weight of the plastic polymer matrix 120. Other possible amount of elastomers can also be included in the present teachings.

Referring back to FIG. 1, by incorporating the core-shell nano-fibrils 110 or 110a, the plastic polymer matrix 120 can be toughened and can further be engineered for use in a variety of applications. In various embodiments, the core-shell nano-fibrils 110 can be dispersed in the plastic polymer matrix 120 having a weight loading of, for example, about 0.5% to about 20% by weight of the plastic polymer matrix 120. Other embodiments can use a weight loading of from about 0.5% to about 15% by weight of the plastic polymer matrix 120, or in some cases, from about 5% to about 10% by weight of the plastic polymer matrix 120.

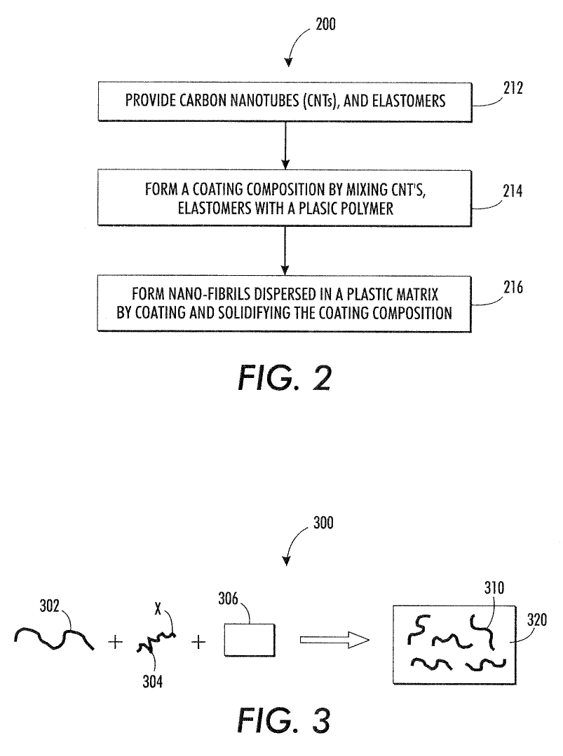

Various embodiments can also include a method for making the composite material 100 in accordance with the present teachings. For example, FIG. 2 depicts an exemplary method 200 for making the disclosed composite material. While the exemplary method 200 is illustrated and described below as a series of acts or events, it will be appreciated that the present teachings are not limited by the illustrated ordering of such acts or events. For example, some acts may occur in different orders and/or concurrently with other acts or events apart from those illustrated and/or described herein, in accordance with the present teachings in addition, not all illustrated steps may be required to implement a methodology in accordance with the present teachings. Further, FIG. 3 schematically illustrates the method for forming the composite material relative to the method 200 of FIG. 2 in accordance with various embodiments of the present teachings.

As shown in FIGS. 2-3, at 212, CNTs 302, elastomers 304 and a plastic polymer 306 can be provided to prepare the disclosed composite material. In an exemplary embodiment, the elastomers 304 can have one or more functional group X capable of being physically and/or chemically attached to the carbon nanotube 302 as disclosed herein.

At 214, the provided CNTs 302, elastomers 304 and the plastic polymer 306 can be blended together to form a coating composition.

In various embodiments, other filler materials, for example inorganic particles, can be used for the coating composition and the subsequently formed composite material. In various embodiments, exemplary inorganic particles can include, metal oxides, non-metal oxides, and metals. Specifically, the metal oxides can include, for example, silicon oxide, aluminum oxide, chromium oxide, zirconium oxide, zinc oxide, tin oxide, iron oxide, magnesium oxide, manganese oxide, nickel oxide, copper oxide, antimony pentoxide, and indium tin oxide. The non-metal oxides can include, for example, boron nitride, and silicon carbides (SiC). The metals can include, for example, nickel, copper, silver, gold, zinc, and iron. In various embodiments, other additives known to one of ordinary skill in the art can also be included to form the disclosed composite materials.

The coating composition can also be prepared to include, for example, an effective solvent, in order to disperse carbon nanotubes, elastomeric polymers and/or corresponding curing agents; plastic polymers, and optionally, inorganic filler particles that are known to one of the ordinary skill in the art.

The effective solvents can include water and/or organic solvents including, but not limited to, methyl isobutyl ketone (MIBK), acetone, methyl ethyl ketone (MEK), and mixtures thereof. Other solvents that can form suitable dispersions can be within the scope of the embodiments herein.

In certain embodiments, the coating composition can include carbon nanotubes, VITON® fluoroelastomers and related curing agents (e.g., a bisphenol curing agent VC-50), fluoroplastic polymers, and optionally, inorganic fillers (e.g., MgO) in an organic solvent (e.g., MIBK).

At 216, the coating composition can then be coated on a suitable substrate and solidified to form a plurality of core-shell nano-fibrils 310 dispersed in a plastic matrix 320 that contains one or more plastic polymers 306. The core-shell nano-fibrils 310 can be formed, as disclosed, by physically or chemically attaching the elastomers 304 onto each carbon nanotube 302 in a core-shell manner.

In various embodiments, the coating composition can be coated using, for example, coating techniques, extrusion techniques and/or molding techniques. As used herein, the term “coating technique” refers to a technique or a process for applying, forming, or depositing a dispersion to a material or a surface. Therefore, the term “coating” or “coating technique” is not particularly limited in the present teachings, and dip coating, painting, brush coating, roller coating, pad application, spray coating, spin coating, casting, or flow coating can be employed.

In various embodiments, the solidification of the coating composition can include a curing process depending on the elastomers and plastic polymers used. In embodiments, prior to the curing process, the coating composition can be partially or wholly evaporated for a length of time. The subsequent curing process can be determined by the polymer(s) and the curing agent(s) used and can include, for example, a step-wise curing process, although any curing schedules known to one of ordinary skill in the art can be within the scope of embodiments herein.

During such blending bonding process of the core-shell nano-fibrils 310, a matrix formation can also take place from the plastic polymer 306. In various embodiments, the composite material can be formed by mixing elastomer pre-grafted carbon nanotubes (i.e., the core-shell nano-fibrils) with the plastic polymer in a solvent to form the coating composition, followed by the coating and solidifying process as disclosed herein.

In various embodiments, the incorporation of the core-shell nano-fibrils into plastic matrix to form the composite material can exhibit certain advantages. For example, the CNT hard cores can provide exceptional mechanical support to the core-shell nano-fibrils and thus to the composite material. When brittle plastic materials are used, the addition of the core-shell nano-fibrils can to improve fracture toughness of the brittle plastic but without negatively impacting the modulus of the toughened plastics. In addition, the CNT hard cores can also provide the composite materials desired electrical (e.g., conductivity), and thermal (e.g., conductivity) functions required by various applications.

Additionally, unlike conventional spherical particle fillers, the CNTs and thus the nano-fibrils can have high aspect ratios. For example, the CNT hard core can have an aspect ratio of from about 10 to about 5,000 or from about 10 to about 1000. In embodiments, other CNTs having an aspect ratio ranging from about 5000 to about 1,000,000 can also be used. The high aspect ratio of CNTs can allow the CNT-based core-shell nano-fibrils to form long range cavitations around the shell layer and thus to effectively relieve stress at lower threshold loading of the plastic polymer matrix. Further, CNTs can be modified/ functionalized through various physical and/or chemical modifications. A variety of shell materials can thus be attached or bonded to the CNT core element. Various desirable core-shell nano-fibrils can thus be designed.

Furthermore, the incorporation of the core-shell nano-fibrils can toughen the brittle polymer matrix by use of various toughening mechanisms. For example, as the brittle plastic polymer matrix is subjected to a load of the core-shell nano-fibrils, and as a crack begins to propagate through the brittle polymer matrix, it is postulated that the core-shell nano-fibrils may allow for fiber bridging, i.e., the bridging of the crack wake by the nano-fibrils. A toughening effect can be achieved when the nano-fibril either distributing load from the crack tip while remaining intact, or absorbing energy through the elastomeric shell layer.

Although not intending to be bound by a particular theory, an alternative mechanism of toughening mechanism can be crack deflection. When a crack propagates through the polymer matrix, the nano-fibril containing a carbon nanotube core being of greater strength than the surrounding material, crack propagation may be deflected away from the axis of highest stress to a less efficient plane directed by the longitudinal orientation of the nano-fibril or its carbon nanotube core This may lead to increased fracture energy through increased fracture surface area, which may be absorbed by the soft shell layer, and lower driving forces due to the reduced resolved normal stresses at the crack tip.

### EXAMPLE

### Example 1

### Composite Preparation Having 2% Carbon Nanotubes Shelled by VITON® Elastomer

About 12 parts of multi-walled carbon nanotubes and 88 parts of VITON® GF (available from E.I. du Pont de Nemours, Inc., Wilmington, Del.) as a shell elastomer were placed in a Haake Rheomix mixer (Thermo Scientific, Waltham, Mass.), and compounded at a rotor speed of 20 rpm for 30 minutes to form nanotube master batch containing 12 weight % of multi-walled carbon nanotubes dispersed in VITON® GF. About 13 parts of the resulted carbon nanotube master batch were then compounded with 67 grams of a fluoro-plastic of THVP221 from Dyneon (Oakdale, Minn.) at about 80° C. in the Haake Rheomix at a rotor speed of 20 rpm for 30 minutes to form a polymer blend containing about 2 weight percent of carbon nanotubes covered by the VITON® elastomer shell.

The THVP/CNT/VITON® blend (4.18 Parts) was mixed with the metal oxides (0.787 part of magnesium oxide and 0.393 part of calcium hydroxide), and 1.68 parts of the bisphenol VC-50 curing agent (VITON® Curative No. 50 available from E.I. du Pont de Nemours, Inc.) in methyl isobutyl ketone (28.4 parts). The resulted coating composition was then cast in a mold. The resulting film after solvent evaporation was cured at ramp temperatures such as about 149° C. for 2 hours, about 177° C. for 2 hours, about 204° C. for 2 hours and at about 232° C. for 6 hours for a post cure.

### Example 2

### Composite Preparation Having 3% Carbon Nanotubes Shelled by VITON® Elastomer

3% carbon nanotubes shelled by a VITON® elastomer was prepared following the procedure described in Example 1, except that about 20 parts of carbon nanotube master batch and about 60 parts of THVP221 were used to make the THVP/3%CNT/VITON® composite blend. The THVP/CNT/VITON® composite blend (4.225 Parts) was mixed with the metal oxides (0.787 part of magnesium oxide and 0.393 part of calcium hydroxide), and 1.9 parts of the bisphenol VC-50 curing agent (VITON® Curative No. 50 available from E.I. du Pont de Nemours, Inc.) in methyl isobutyl ketone (28.5 parts) to form a coating composition, which was then cast in a mold. The resulting film after solvent evaporation was cured at ramp temperatures such as about 149° C. for 2 hours, about 177° C. for 2 hours, about 204° C. for 2 hours and at about 232° C. for 6 hours for a post cure.

Example 3: Comparative Example-1

### l Preparation of THVP Plastic Film

The THVP coating composition was prepared by mixing the THVP221 (4.10 parts), metal oxides (0.787 part of magnesium oxide and 0.393 part of calcium hydroxide), and the bisphenol VC-50 curing agent (1.68 parts, VITON® Curative No. 50 available from E.I. du Pont de Nemours, Inc.) in methyl isobutyl ketone (27.5 parts). The coating composition was then cast in a mold. The resulting film after solvent evaporation was cured at ramp temperatures such as about 149° C. for 2 hours, about 177° C. for 2 hours, about 204° C. for 2 hours and at about 232° C. for 6 hours for a post cure. In this manner, the comparative Example-1 of the plastic film included the fluoro-plastic matrix but no VITON® elastomers or carbon nanotubes involved as compared with Examples 1-2.

### Example 4

### Comparative Example-2

### Preparation of THVP/VITON® Composite

THVP/ VITON® coating composition was prepared following the procedure described in Example 1, except that 68 grams of THVP221 and 12 grams of VITON® GF pellets GF (available from E.I. du Pont de Nemours, Inc.) were used and no carbon nanotubes were involved. Such coating composition was cast into a film following the procedure described in Examples 1-4. In this manner, the comparative Example-2 included the fluoro-plastic matrix having VITON® elastomers dispersed therein but no carbon nanotubes involved as compared with Examples 1-2.

### Example 5

### Mechanical Properties

Each cured composite film of Examples 1-4 was cut into 5 specimens that were then subjected to a mechanical test and averaged for each example of Examples 1-4. The mechanical test was performed using ASTM D412 Tensile Properties of Elastomers (Thomson Scientific, Chicago, Ill.). The results were summarized in Table 1 as following.

TABLE 1

| | Film | Tensile | Tensile | Modulus | |
|---|---|---|---|---|---|
| | Thickness | stress | strain | (Young's) | |
| Examples | (mil) | (Psi) | (%) | (Psi) | Toughness |
| Example-1 | 13.7 | 955.6 | 142.1 | 1740.1 | 806.3 |
| Example-2 | 17.6 | 1223.8 | 158.5 | 4397.5 | 1283.0 |
| Comparative | 14.8 | 327.7 | 136.9 | 928.7 | 332.7 |
| Example-1 | | | | | |
| Comparative | 13.2 | 499.2 | 163.2 | 1044.6 | 546.5 |
| Example-2 | | | | | |

As indicated by Table 1, the composite coatings (see Examples 1-2) including core-shell nano-fibrils, i.e. including CNT shelled by soft elastomer, can be significantly improved in both young's modulus and mechanical toughness as compared with composites (see Comparative Examples 1-2) not including the disclosed core-shell nano-fibrils.

While the present teachings have been illustrated with respect to one or more implementations, alterations and/or modifications can be made to the illustrated examples without departing from the spirit and scope of the appended claims. In addition, while a particular feature of the present teachings may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.” As used herein, the term “one or more of” with respect to a listing of items such as, for example, A and B, means A alone, B alone, or A and B. The term “at least one of” is used to mean one or more of the listed items can be selected.

Notwithstanding that the numerical ranges and parameters setting forth the broad scope of the present teachings are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume values as defined earlier plus negative values, e.g. −1, −1.2, −1.89, −2, −2.5, −3, −10, −20, −30, etc.

Other embodiments of the present teachings will be apparent to those skilled in the art from consideration of the specification and practice of the present teachings disclosed herein. It is intended that the specification and examples be considered as exemplary only, with a true scope and spirit of the present teachings being indicated by the following claims.

1. A composite material comprising:
a plastic matrix comprising one or more plastic polymers; and
a plurality of core-shell nano-fibrils dispersed in the plastic matrix, wherein each core-shell nano-fibril comprises a carbon nanotube surrounded by a shell layer, the shell layer comprising one or more elastomers.

2. The composite material of claim 1, wherein the one or more plastic polymers comprise a thermoplastic polymer or a thermosetting polymer.

3. The composite material of claim 2, wherein the thermoplastic polymer comprises one or more monomeric repeat units selected from the group consisting of an ethylene, a propylene, a styrene, a vinyl chloride, a tetrafluoroethylene, a vinylidene fluoride, a hexafluoropropylene, a chlorotrifluoroethylene, a perfluoro(methyl vinyl ether), a perfluoro(ethyl vinyl ether), a perfluoro(propyl vinyl ether), and mixtures thereof.

4. The composite material of claim 2, wherein the thermoplastic polymer is selected from the group consisting of a polyethylene, a polypropylene, a polystyrene, a poly(vinyl chloride), a fluoroplastics, a polyacetal, an acrylic, a polyamide, a polycarbonate, a polyester, a polyphenylene oxide, a polyketone, a polysulfone, a polyetheretherketone, a polyether-imide, a polyimide, and combinations thereof.

5. The composite material of claim 2, wherein the thermosetting polymer is selected from the group consisting of an epoxy, a melamine-formaldehyde, a urea-formaldehyde, an unsaturated polyester, a phenolic resin, an alkyl, a polyurethane, and mixtures thereof.

6. The composite material of claim 1, wherein the one or more plastic polymers are selected from the group consisting of a crystalline polymer, a semi-crystalline polymer, an amorphous polymer and combinations thereof.

7. The composite material of claim 1, wherein the shell layer has a thickness of at least about 1 nanometer.

8. The composite material of claim 1, wherein the shell layer has a thickness ranging from about 1 nanometer to about 5 micrometers.

9. The composite material of claim 1, wherein the one or more elastomers comprise a natural rubber or a synthetic rubber.

10. The composite material of claim 1, wherein the one or more elastomers comprise a synthetic rubber selected from the group consisting of a polyolefin comprising one or more monomeric repeat units of olefin having from about 1 to about 12 carbons, a fluoroelastomer, a perfluoroelastomer, a silicone, a fluorosilicone, a polysulfide, a polyphosphazene, and mixtures thereof.

11. The composite material of claim 1, wherein the one or more elastomers are at least partially vulcanized.

12. The composite material of claim 1, wherein the one or more elastomers further comprise a functional group capable of bonding with a carbon nanotube.

13. The composite material of claim 12, wherein the functional group capable of bonding with the carbon nanotube is selected from the group consisting of a hydroxyl, a carboxylic acid, an aziridine, an azomethine ylide, an aryl diazonium cation, an oxazolidinone, and mixtures thereof.

14. The composite material of claim 1, wherein each carbon nanotube comprises an aspect ratio ranging from about 10 to about 5000.

15. The composite material of claim 1, wherein each carbon nanotube comprises a single wall carbon nanotube (SWCNT) or a multi-wall carbon nanotube (MWCNT).

16. The composite material of claim 1, wherein the plurality of nano-fibrils is present in an amount ranging from about 0.5% to about 20% by weight of the plastic matrix.

17. The composite material of claim 1, wherein the one or more elastomers are present in an amount ranging from about 0.5% to 10% by weight of the plastic matrix.

18. A method for making a composite material comprising:
forming a coating composition by mixing a plurality of carbon nanotubes and one or more elastomers with a plastic polymer in a solvent, wherein each elastomer is capable of being attached to the carbon nanotube to form a shell layer; and
forming a plurality of core-shell nano-fibrils dispersed in a plastic matrix by applying the coating composition to a substrate and solidifying the coating composition such that the plastic matrix comprises the plastic polymer and each core-shell nano-fibril comprises the one or more elastomers as the shell layer surrounding the carbon nanotube.

19. The method of claim 18, wherein the coating composition further comprises one or more filler particles comprising metal oxides, silicon carbides, boron nitrides, and graphites, wherein the metal oxides are selected from the group consisting of silicon oxide, aluminum oxide, zirconium oxide, zinc oxide, tin oxide, iron oxide, magnesium oxide, manganese oxide, nickel oxide, copper oxide, antimony pentoxide, indium tin oxide, and mixtures thereof.

20. The method of claim 18, wherein the coating composition is formed to include a VITON® fluoroelastomer along with a bisphenol curing agent, a plurality of carbon nanotubes, a fluoroplastic, and a plurality of oxide fillers comprising a magnesium oxide, a calcium hydroxide in the solvent of methyl isobutyl ketone.
